(19) United States
(12) Patent Application Publication
(10) Pub. No.: US 2021/0086386 A1
(43) Pub. Date: Mar. 25, 2021

(54) SOFT TUBE GRIPPER FOR PUNCHING

(71) Applicant: Cook Medical Technologies LLC, Bloomington, IN (US)

(72) Inventors: Andreas Ott, Limerick (IE); Pat Kelly, Limerick (IE)

(73) Assignee: Cook Medical Technologies LLC, Bloomington, IN (US)

(21) Appl. No.: 17/022,863

(22) Filed: Sep. 16, 2020

Related U.S. Application Data
(60) Provisional application No. 62/903,133, filed on Sep. 20, 2019.

(51) Int. Cl. B26D 7/01; B25B 5/02

(52) U.S. Cl. CPC B26D 7/01; B26F 1/3846; B25B 5/02

(57) ABSTRACT

A gripper for gripping a tube for punching may include a first arm having a lower portion and an upper portion disposed outwardly from an upper surface of the lower portion. The upper portion extends to opposite first and second side surfaces and opposite third and fourth side surfaces, where opposite edges of the first and second side surfaces each meet an edge of one of the opposite third and fourth side surfaces. The second side surface includes a groove extending from the second side surface towards the first side surface and along a length of the second side surface. The groove is configured to receive at least a portion of a tube when a second arm like the first arm is disposed adjacent to and aligned with the first arm.

### CROSS-REFERENCE TO RELATED APPLICATIONS

This application claims priority U.S. Provisional Application Ser. No. 62/903,133, filed Sep. 20, 2019, which is incorporated herein by reference in its entirety.

### TECHNICAL FIELD

The present disclosure relates to a soft tube gripper for punching the soft tube without an internal support disposed in the soft tube.

### BACKGROUND

As part of the manufacturing process of punching apertures in the wall of a soft tube, a supporting tube is placed up through the lumen of the soft tube, which prevents the soft tube from collapsing as it is being punched. The addition of the supporting tube to enable clean punching costs operator times and materials needed for the supporting tube. The necessity of placing a supporting tube into the soft tube to be punched before punching also makes it difficult to automate the punching operation from start to finish.

### BRIEF SUMMARY OF THE INVENTION

One general aspect of the present disclosure includes a gripper for gripping a tube for punching, including: a first arm including a lower portion and an upper portion disposed outwardly from an upper surface of the lower portion, where the upper portion extends to opposite first and second side surfaces and opposite third and fourth side surfaces, where opposite edges of the first and second side surfaces each meet an edge of one of the opposite third and fourth side surfaces, where the second side surface includes a groove extending from the second side surface towards the first side surface and along a length of the second side surface, and where the groove is configured to receive at least a portion of a tube when a second arm like the first arm is disposed adjacent to and aligned with the first arm.

Another general aspect of the present disclosure includes a gripper for gripping a soft tube for punching, including: a first arm and a second arm, where the first arm and the second arm are moveable relative to each other, where the gripper has an open configuration and a closed configuration, and where the first arm and the second arm are configured such that when the gripper is in the closed configuration, a tunnel is formed collectively by the first and second arms and configured to receive at least a portion of a soft tube such that at least the portion of the soft tube received in the tunnel is prevented from collapsing when force is applied to a wall of the portion of the soft tube received in the tunnel.

Another general aspect of the present disclosure includes a gripper for gripping a tube for punching, including: a first arm including a lower portion and an upper portion disposed outwardly from an upper surface of the lower portion, where the upper portion extends to opposite first and second side surfaces and opposite third and fourth side surfaces, where opposite edges of the first and second side surfaces each meet an edge of one of the opposite third and fourth side surfaces, and where the second side surface includes a groove extending from the second side surface towards the first side surface and along a length of the second side surface.

Other systems, methods, features and advantages of the invention will be, or will become, apparent to one with skill in the art upon examination of the following figures and detailed description. It is intended that all such additional systems, methods, features, and advantages be within the scope of the invention, and be encompassed by the following claims.

### BRIEF DESCRIPTION OF THE DRAWINGS

The present disclosure can be better understood with reference to the following drawings and description. The components in the figures are not necessarily to scale, emphasis instead being placed upon illustrating the principles of the present disclosure. Moreover, in the figures, like-referenced numerals designate corresponding parts throughout the different views.

FIG. 1 is a perspective view of an arm of a gripper in accordance with certain aspects of the present disclosure.

FIG. 2 is a top perspective view of the arm of FIG. 1 in accordance with certain aspects of the present disclosure.

FIG. 3 is a top view of the arm of FIG. 1 in accordance with certain aspects of the present disclosure.

FIG. 4 is a perspective view of a gripper including two arms of FIG. 1 in accordance with certain aspects of the present disclosure.

FIG. 5 is a top perspective view of the gripper of FIG. 4 in accordance with certain aspects of the present disclosure.

FIG. 6 is a front perspective view of the gripper of FIG. 4 in a closed configuration in accordance with certain aspects of the present disclosure.

FIG. 7 is a perspective view of the gripper of FIG. 4 supported on a moving device in accordance with certain aspects of the present disclosure.

FIG. 8 is a top perspective view of the gripper of FIG. 7 supported on the moving device in accordance with certain aspects of the present disclosure.

FIGS. 9-16 are perspective views of the gripper of FIG. 4 supported on a moving device showing methods of using the gripper to punch apertures in the wall of a tube in accordance with certain aspects of the present disclosure.

### DETAILED DESCRIPTION

Various aspects are described below with reference to the drawings in which like elements generally are identified by like numerals. The relationship and functioning of the various elements of the aspects may better be understood by reference to the following detailed description. However, aspects are not limited to those illustrated in the drawings or explicitly described below. It also should be understood that the drawings are not necessarily to scale, and in certain instances details may have been omitted that are not necessary for an understanding of aspects disclosed herein, such as conventional material, construction, and assembly.

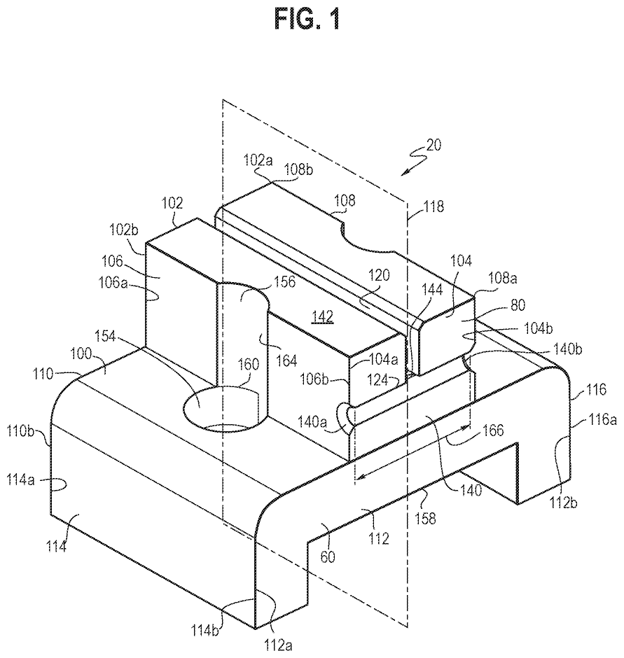

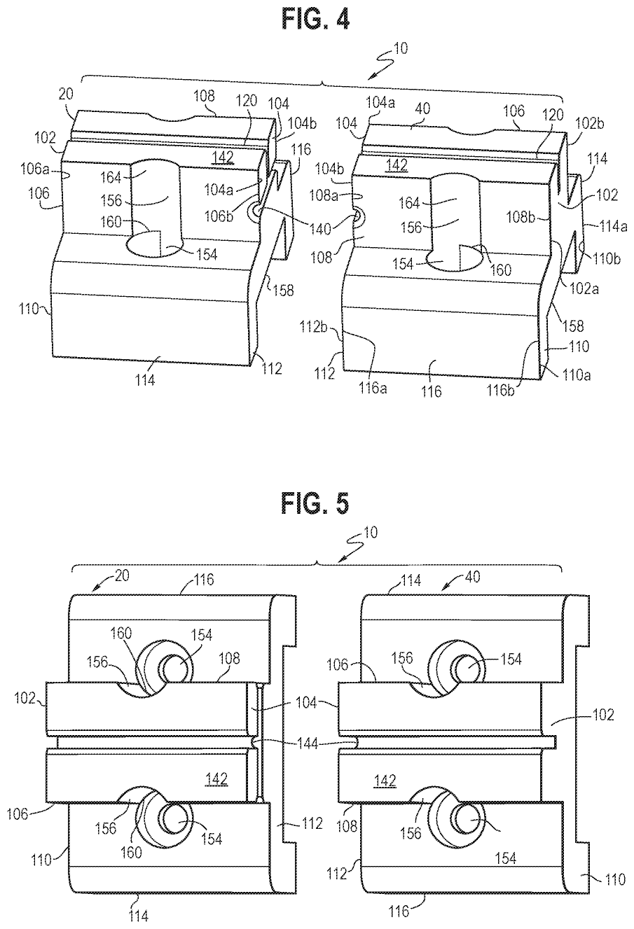

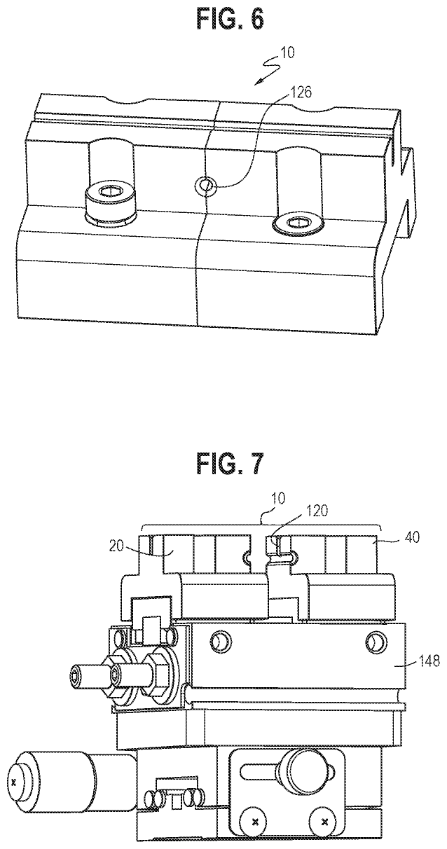

Turning now to FIGS. 1-16, a gripper 10 is provided. The gripper 10 includes a first arm 20 and a second arm 40 like the first arm (e.g., the second arm 40 is identical to the first arm 20, as shown in FIG. 4). The gripper is configured to receive at least a portion of a tube and provide external support to the received portion of the tube such that the portion of the tube is prevented from collapsing (e.g., is forced by the gripper to maintain the tube's original/default outer diameter) as a wall of the portion of the tube is being punched without the need for placing an internal support (e.g., supporting tube) into the tube before punching. While the gripper 10 is specifically described and depicted as a gripper for receiving and supporting a tube for punching, the gripper may be successfully implemented for providing similar external support to other objects during punching. One of ordinary skill in the art, with a thorough review of the subject specification and figures will readily comprehend how the gripper may be used for punching objects other than tubes, for purposes of eliminating the need for disposing an internal support in the objects before punching, and will readily comprehend which other objects might be suitable without undue experimentation.

The first arm 20 of the gripper 10 is best shown in FIGS. 1-5. The first arm 20 may include a lower portion 60 and an upper portion 80 disposed outwardly from an upper surface 100 of the lower portion 60. The upper portion 80 may extend to opposite first and second side surfaces 102 and 104 and opposite third and fourth side surfaces 106 and 108. The first and second side surfaces extend to edges 102a, 102b, 104a, and 104b, and the third and fourth side surfaces extend to edges 106a, 106b, 108a, and 108b that meet with respective edges of the first and second side surfaces 102 and 104 at respective intersections. In some embodiments, as shown in FIGS. 1-5, the first and second side surfaces 102 and 104 are parallel, the third and fourth side surfaces 106 and 108 are parallel, and the third and fourth side surfaces 106 and 108 each are disposed generally perpendicular to the first and second side surfaces 102 and 104.

The lower portion 60 may extend to opposite fifth and sixth side surfaces 110 and 112 and opposite seventh and eighth side surfaces 114 and 116. The fifth and sixth side surfaces extend to edges 110a, 110b, 112a, and 112b, and the seventh and eighth side surfaces extend to edges 114a, 114b, 116a, and 116b that meet with respective edges of the fifth and sixth side surfaces 110 and 112 at respective intersections. In some embodiments, as shown in FIGS. 1-5, the fifth and sixth side surfaces 110 and 112 are parallel, the seventh and eighth side surfaces 114 and 116 are parallel, and the seventh and eighth side surfaces 114 and 116 each are disposed generally perpendicular to the fifth and sixth side surfaces 110 and 112.

In some embodiments, as shown in FIGS. 1-5, the upper portion 80 extends along a center plane 118. The center plane 118 extends between the fifth and sixth side surfaces 110 and 112, and in parallel to and centered by the seventh and eighth side surfaces 114 and 116. The center plane 118 also extends between the first and second side surfaces, and in parallel to and centered by the third and fourth side surfaces. In other words, the third and fourth side surfaces 106 and 108 of the upper portion 80 are disposed equidistant from the center plane 118 and the seventh and eighth side surfaces 114 and 116 are disposed equidistant from the center plane 118.

This configuration allows a gripper 10 to be assembled using a first arm 20 and a second arm 40 (like the first arm 20) with a tunnel 126 or space 130 formed collectively by grooves 140 of the first and second arms 20 and 40, and a passage 136 formed collectively by slots 120 (or together with cutouts 144) of the first and second arms 20 and 40, as discussed in greater detail below. As shown in FIGS. 4-6, to assemble the gripper 10, the second arm 40 is disposed adjacent to and aligned with the first arm 20, and the second arm 40 is positioned such that the second side surface 104 of the second arm 40 is adjacent to the second side surface 104 of the first arm 20, with the third side surface 106 of the first arm 20 extending along a same plane with a fourth side surface 108 of the second arm 40, and the fourth side surface 108 of the first arm 20 extending along a same plane with the third side surface 106 of the second arm 40.

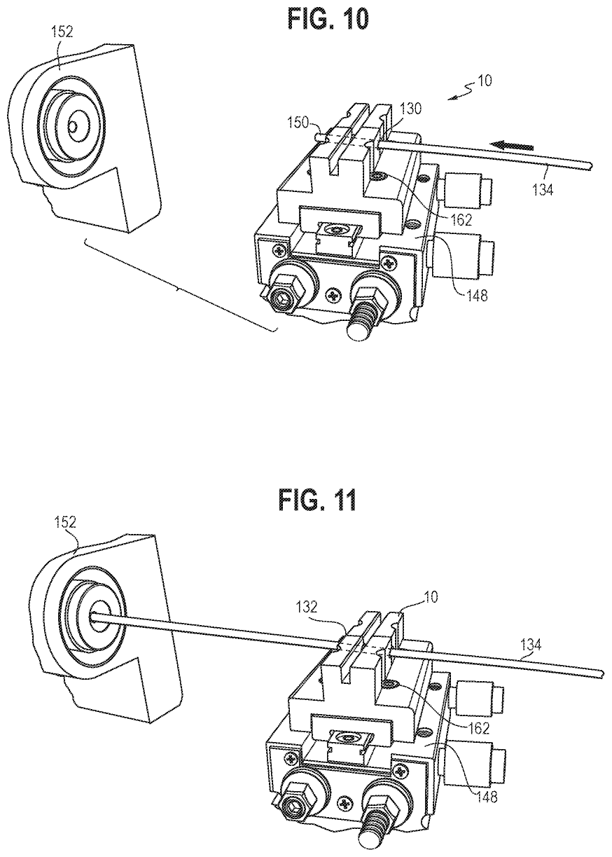

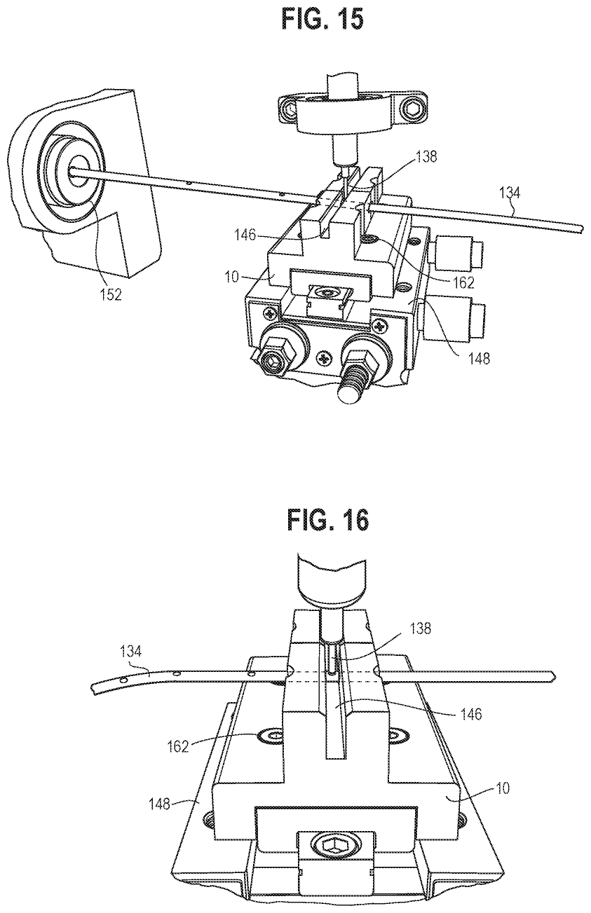

Then the first arm 20 and/or the second arm 40 may be moved towards each other until they are spaced apart a predetermined distance 132 (e.g., as shown in FIG. 11), and thereby adjusting the gripper 10 to an open configuration. When the gripper 10 is in the open configuration, a space 130 (e.g., as shown in FIG. 9) is formed collectively by grooves 140 of the first and second arms 20 and 40, as discussed in greater detail below. The first arm 20 and/or the second arm 40 may be further moved towards each other, with or without a tube 134 extending through the space 130, until the second side surfaces 104 of the first and second arms 20 and 40 closely contact each other (e.g., except for the area of the grooves 140, no visual space between the edge 104a of the first arm 20 and the edge 104b of the second arm 40 or between the edge 104b of the first arm 20 and the edge 104a of the second arm 40, as shown in FIG. 6), and thereby adjusting the gripper 10 to a closed configuration. When the gripper 10 is in the closed configuration, a tunnel 126 (e.g., as shown in FIG. 6) is formed collectively by grooves 140 of the first and second arms 20 and 40, as discussed in greater detail below.

In some embodiments, as shown in FIGS.1-4, the second side surface 104 and the sixth side surface 112 extend through a same plane, the first side surface 102 and the fifth side surface 110 extend through a same plane, and the third and fourth side surfaces 106 and 108 are disposed closer to the center plane 118 than the seventh and eighth side surfaces 114 and 116. It will be appreciated that these features of the first arm 20 may be varied as desired and/or needed without departing from the scope of the present invention as long as the gripper 10 may be assembled using the first arm 20 and a second arm 40 (like the first arm 20), as discussed above. As one non-limiting example, the second side surface 104 may extend outwardly from the sixth side surface 112 such that when the gripper 10 is assembled as discussed above, the second side surfaces 104 of the first and second arms 20 and 40 may closely contact each other without the sixth side surfaces 112 of the first and second arms 20 and 40 contacting each other. As another non-limiting example, the third and fourth side surfaces 106 and 108 may be disposed further away from the center plane 118 than the seventh and eighth side surfaces 114 and 116. As another non-limiting example, the third and fourth side surfaces 106 and 108 and the seventh and eighth side surfaces 114 and 116 may be disposed equidistant from the center plane 118.

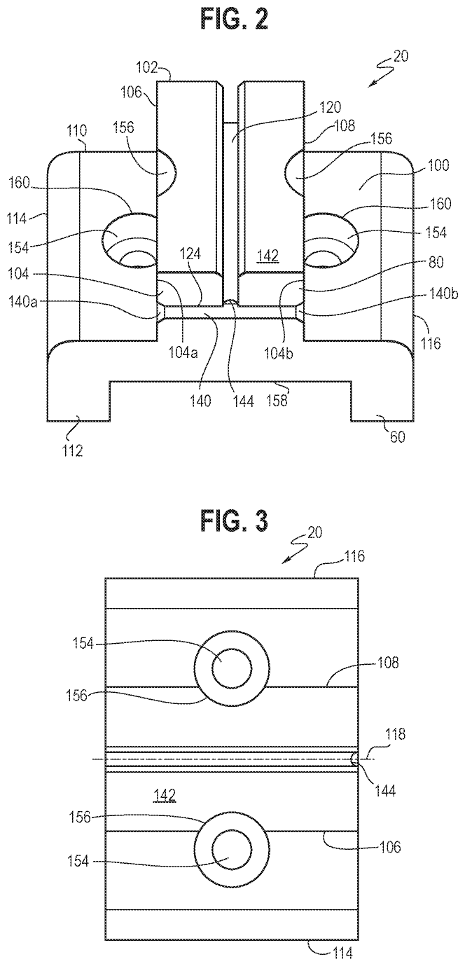

As shown in FIGS. 1, 2, and 4, the second side surface 104 of the first arm 20 includes a groove 140 extending from the second side surface 104 towards the first side surface 102 and along a length 166 of the second side surface 104. The groove has a curved surface with a generally semicircular cross-section, such that when the gripper 10 is assembled using the first arm 20 and the second arm 40 (like the first arm 20) and adjusted to the open configuration, as discussed above, a space 130 (e.g., as shown in FIG. 9) is formed collectively by grooves 140 of the first and second arms 20 and 40. The space 130 is configured to slidably and rotatably receive at least a portion of a tube 134. With at least a portion of a tube 134 extending through the space 130, the gripper 10 may be adjusted to the closed configuration, as discussed above, such that a tunnel 126 with a generally circular cross-section (e.g., as shown in FIG. 6) is formed collectively by grooves 140 of the first and second arms 20 and 40. In the closed configuration, the groove 140 (and the tunnel 126) is configured to receive at least a portion of a tube 134 (e.g., as shown in FIGS. 12 and 13). The two ends 140a and 140b of the groove 140 may be chamfered, as shown in FIGS. 1 and 2, to facilitate guiding the tube 134 in and out the groove 140 (and thus in and out the tunnel 126 or the space 130).

The groove 140 is configured such that, when the gripper 10 is in the closed configuration, the portion of the tube 134 received in the tunnel 126 is prevented from collapsing when force is applied to a wall of the portion of the tube received in the tunnel 126 (e.g., when the wall is being punched). In other words, the groove 140 is configured such that the portion of the tube 134 received in the tunnel 126 is engaged or closely surrounded by the internal surface of the tunnel 126 such that the portion of the tube is forced (e.g., supported externally) to its default outer diameter (an outer diameter when no force is applied to the tube), thereby not allowing the portion of the tube 134 to deflect away out of shape from the force being applied to the wall of the portion of the tube 134 (e.g., a drill while being punched) as would happen if there is no internal support placed in the tube 134. Accordingly, this configuration is advantageous for allowing the tube 134 to be punched without an inner support positioned within the tube 134 before punching, and thereby enhancing the efficiency, saving labor and materials used for supporting the tube, and also allowing the punching operation to be automated (discussed below).

To provide the above mentioned external support to a tube secured by the gripper 10, the groove 140 is configured to have a marginally smaller closed diameter (e.g., the inner diameter of the tunnel 126) than the default outer diameter of the tube. As one non-limiting example, in the embodiments where the tunnel 126 has a generally circular cross-section (e.g., as shown in FIG. 6), the tunnel 126 has an inner diameter that is between about 1% and about 5% smaller than the default outer diameter of the portion of the tube 134 received in the tunnel 126. The term “about” is specifically defined herein to include the specific value referenced as well as a dimension that is within 5% of the dimension both above and below the dimension. It will be appreciated that the inner diameter of the tunnel 126 may be varied depending on the characteristics of the tube 134, including but not limited to the default outer diameter, material, and wall thickness of the tube 134, without departing from the scope of the present disclosure, as long as the portion of the tube 134 received in the tunnel 126 is prevented from collapsing when force is applied to a wall of the portion of the tube 134. In addition, it will be appreciated that by varying the configuration (e.g., shape, size, length) of the groove 140, the configuration of the cavity formed collectively by the grooves 140 of the first and second arms 20 and 40, when the gripper 10 is assembly as discussed above, may be varied to accommodate various configurations of objects other than tubes, such that these objects may be received in the formed cavity and supported externally by the grooves 140 of the first and second arms 20 and 40, and thus can be punched without internal support.

As shown in FIGS. 1, 2, 4 and 5, the upper portion 80 of the first arm 20 also includes a slot 120 that extends from the second side surface 104 towards the first side surface 102, and extends from a top surface 122 of the upper portion 80 towards the upper surface 100 of the lower portion 60 and to a plane that at least meets the groove 140 at an upper edge 124 of the groove 140. The upper edge 124 of the groove 140 may include a cutout 144 (e.g., as shown in FIGS. 1-3, 5) extending within the slot 120 from the second side surface 104 towards the first side surface 102.

The slot 120 (and thus the cutout 144) is disposed along the center plane 118, such that when the gripper 10 is assembled as discussed above, a passage 136 (e.g., as shown in FIGS. 12-14) is formed collectively by the slots 120 (or together with the cutouts 144) of the first and second arms 20 and 40. The slot 120 (or together with the cutout 144) is configured (e.g., shaped and sized) such that the formed passage 136 allows at least a portion of an elongate member 138 (e.g., as shown in FIGS. 13-14) to extend from above top surfaces 142 of the first and second arms 20 and 40, through the passage 136, and into grooves 140 (e.g., into the tunnel 126 when the gripper 10 is in the closed configuration) of the first and second arms 20 and 40. This configuration allows a tool (e.g., a bit of a driller as shown in FIGS. 13-16) extending from above the gripper 10 to punch apertures in the wall of the portion of the tube 134 received in the tunnel 126 when the gripper 10 is in the closed configuration, as discussed in greater detail below.

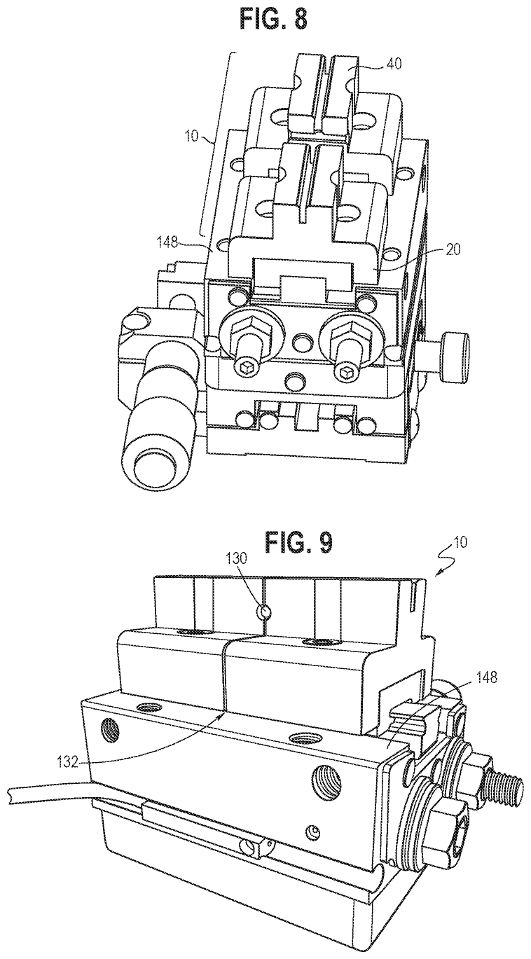

It will be appreciated that, when the gripper 10 is used for punching apertures on a wall of a tube 134, the configuration of the slot 120 (or together with the cutout 144) may be varied depending on the configuration (e.g., shape and size) of the apertures to be created on the wall of the tube 134 extending through the tunnel 126 and thus also depending on the configuration of the punching portion (e.g., the elongate member 138 as shown in FIGS. 13 and 14) of a punching device. As one non-limiting example, the cutout 144 may have a curved surface with a generally semicircular cross-section (e.g., as shown in FIG. 5), such that when the gripper 10 is assembled using the first arm 20 and the second arm 40 (like the first arm 20) and adjusted to the closed configuration, as discussed above, an opening with a generally circular cross-section is formed collectively by the cutouts 144 of the first and second arms 20 and 40 to accommodate a punching portion with a generally circular cross-section.

The slot 120 may also be configured to allow for a relative movement between the elongate member 138 and the first and second arms 20 and 40 of the gripper 10 when a portion of the elongate member 138 has extended into the passage 136. As one non-limiting example, as shown in FIGS. 1, 2 and 12-15, the slot 120 may extend from the second side surface 104 to the first side surface 102, such that when the gripper 10 is assembled, the slots 120 of the first and second arms 20 and 40 form a continuous valley 146 (e.g., as shown in FIGS. 12-16) that allows the elongate member 138 to move out of the gripper 10 along the valley 146 without the need for moving the portion of the elongate member 138 extended into the passage 136 up to a level above the top surfaces 142 of the first and second arms 20 and 40. This is advantageous for easy removal of the elongate member 138 from the gripper 10 and easy insertion of the elongate member 138 into the gripper 10. For example, when the gripper 10 is used for punching apertures with different configurations on a wall of a tube 134, punching portions (e.g., bits of a driller) of the punching device with different configurations may be needed along the length of the tube 134. This configuration allows a punching portion to be easily moved out of the gripper 10, changed to a different punching portion, and then easily moved back into the passage 136 through the valley 146, without the need for repeatedly moving the punching device up and down, and thereby enhancing the efficiency and saving labor.

In some embodiments, the valley 146 is provided to allow for the elongate member 138 to deposit a swarf (portion of the tube removed from the tube during the punching operation) that is removed from the tube within the valley after the cutting operation, such that the swarf does not remain upon the tube or otherwise interfere with the punching process of the tube being punched or future tubes to be punched. In some embodiments, compressed air may be flow through the valley 146 to urge the swarfs out of the valley 146 and into a container to be collected.

In some embodiments, as shown in FIGS. 1-5, the lower portion 60 may include a pair of holes 154 disposed on opposite sides of the center plane 118. The pair of holes 154 may extend from the upper surface 100 of the lower portion 60 to a bottom surface 158 and configured to allow a pair of bolts 162 to be respectively extended therethrough for securing the lower portion 60 onto a supporting device (e.g., the lower portion 60 is secured onto a moving device 148, as shown in FIGS. 10-16). The pair of holes 154 may be disposed equidistant from the center plane 118. Each of the third and fourth side surfaces 106 and 108 may include a recess 156 configured to facilitate easy removal and insertion of the bolts 162. As shown in FIGS. 1-5, the recess 156 is configured to extend from the upper surface 100 of the lower portion 60 (e.g., extending from at least a portion of the upper circumference 160 of the hole 154) to the top surface 142, and the internal surface 164 of the recess 156 is configured to have a curvature that is the same as or similar to at least a portion of the upper circumference 160 of the hole 154.

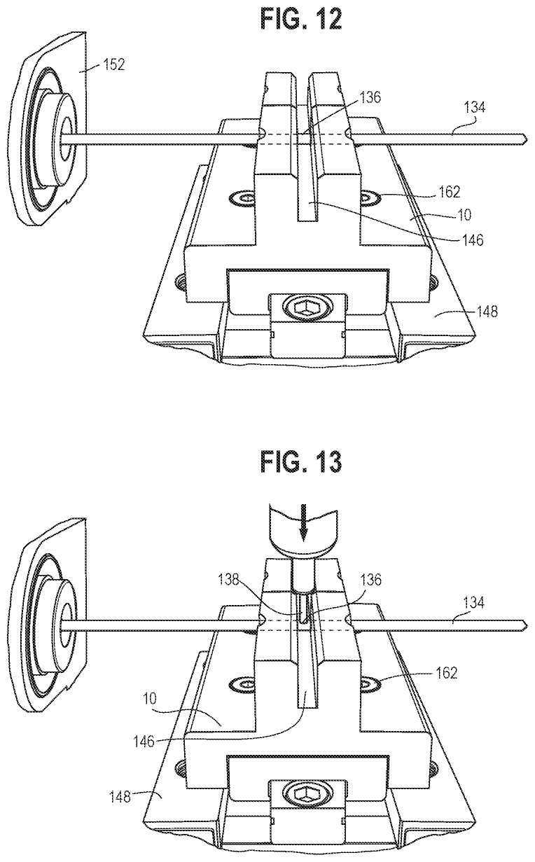

As shown in FIGS. 7-16, the gripper 10 may be used with other devices to automate the punching operation of a tube. The specific devices shown in these figures and methods of punching described below are just for illustration purposes. One of ordinary skill in the art, with a thorough review of the subject specification and figures will readily comprehend how the gripper may be used with the same devices for punching tubes by other methods, will readily comprehend how the gripper may be used with other devices for punching tubes or other objects, for purposes of eliminating the need for disposing an internal support in the objects before punching, and will readily comprehend which other devices might be suitable without undue experimentation.

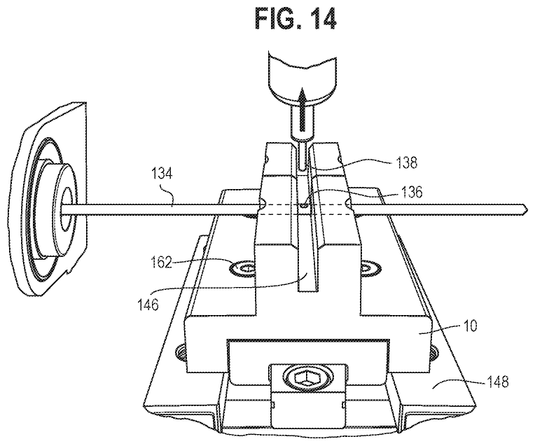

Referring to FIGS. 7-16, the first and second arms 20 and 40 are placed on and supported by a moving device 148, such that a gripper 10 is assembled on the moving device 148, as discussed above, using the first and second arms 20 and 40, as shown in FIGS. 7 and 8. The moving device 148 is configured to automatically adjust the gripper 10 between the open configuration and the closed configuration by moving the first arm 20 and/or the second arm 40 towards or away from each other, as discussed above. As shown in FIG. 9, the gripper 10 has been adjusted to the open configuration with a space 130 formed between the first and second arms 20 and 40. Then an operator may insert a distal end portion 150 of a tube 134 into the space 130 from one end of the space 130 and extend the tube 134 through the space 130 until the distal end portion 150 of the tube 134 is out of the other end of the space 130 and received by a receiving device 152, as shown in FIGS. 10 and 11. The receiving device 152 is configured to automatically move the tube 134 through the space 130 and rotate the tube 134 such that apertures may be created along the length and around the surface of the tube 134. In some embodiments, as shown in FIG. 16, an operator may manually control the movement of the tube 134.

Before punching, the gripper is adjusted to the closed configuration, as shown in FIG. 12. Then a punching device (e.g., a driller) is positioned such that the punching portion 138 (e.g., the bit of the driller) extends through the passage 136, into the tunnel 126, and through a wall of the portion of the tube 134 received in the tunnel 126 (thereby creating an aperture on the wall of the tube), as shown in FIG. 13. After an aperture is created, as shown in FIG. 14, the punching portion 138 is automatically moved up and outside the tunnel 126, and the gripper 10 is automatically adjusted to the open configuration (simultaneously or shortly thereafter). Then, as shown in FIG. 15, the receiving device 152 may automatically move further away from the gripper 10 (such that the tube 134 is further extended through the space 130) and/or rotate the tube 134, until a desired area of the tube 134 is disposed in registry with the passage 136, such that apertures may be created at desired locations along the length and around the surface of the tube 134.

While various embodiments of the present disclosure have been described, the present disclosure is not to be restricted except in light of the attached claims and their equivalents. One skilled in the relevant art will recognize that numerous variations and modifications may be made to the embodiments described above without departing from the scope of the present invention, as defined by the appended claims. Moreover, the advantages described herein are not necessarily the only advantages of the present disclosure and it is not necessarily expected that every embodiment of the present disclosure will achieve all of the advantages described.

We claim:

1. A gripper for gripping a tube for punching, comprising:
a first arm including a lower portion and an upper portion disposed outwardly from an upper surface of the lower portion,
wherein the upper portion extends to opposite first and second side surfaces and opposite third and fourth side surfaces,
wherein opposite edges of the first and second side surfaces each meet an edge of one of the opposite third and fourth side surfaces,
wherein the second side surface includes a groove extending from the second side surface towards the first side surface and along a length of the second side surface, and
wherein the groove is configured to receive at least a portion of a tube when a second arm like the first arm is disposed adjacent to and aligned with the first arm.

2. The gripper of claim 1, wherein when the second arm is disposed adjacent to and aligned with the first arm, the second arm is positioned such that a second side surface of the second arm is adjacent to the second side surface of the first arm, with the third side surface of the first arm extending along a same plane with a fourth side surface of the second arm, and the fourth side surface of the first arm extending along a same plane with a third side surface of the second arm.

3. The gripper of claim 1, wherein the groove of the first arm is configured such that, when the second arm is disposed aligned with the first arm and positioned such that second side surfaces of the first and second arms are in contact with each other, a tunnel is formed collectively by grooves of the first and second arms.

4. The gripper of claim 3, wherein the tunnel is configured to receive at least a portion of a tube such that the portion of the tube received in the tunnel is prevented from collapsing when force is applied to a wall of the portion of the tube received in the tunnel.

5. The gripper of claim 4, wherein the tunnel has an inner diameter that is between about 1% and about 5% smaller than a default outer diameter of the portion of the tube received in the tunnel.

6. The gripper of claim 1, wherein the groove is configured such that, when the second arm is disposed aligned with the first arm and positioned such that second side surfaces of the first and second arms are spaced apart a predetermined distance, a space is formed collectively by grooves of the first and second arms, and wherein the space is configured to slidably and rotatably receive at least a portion of a tube.

7. The gripper of claim 1, wherein the upper portion further includes a slot, wherein the slot extends from the second side surface towards the first side surface, and wherein the slot extends from a top surface of the upper portion towards the upper surface of the lower portion and to a plane that at least meets the groove at an upper edge of the groove.

8. The gripper of claim 7, wherein the slot is disposed along a center plane that extends between the first and second side surfaces and in parallel to and centered by the third and fourth side surfaces.

9. The gripper of claim 7, wherein the upper edge of the groove further includes a cutout extending within the slot from the second side surface towards the first side surface.

10. The gripper of claim 9, wherein when the second arm is disposed adjacent to and aligned with the first arm, slots and cutouts of the first and second arms collectively form a passage configured to allow at least a portion of an elongate member to extend from above top surfaces of the first and second arms, through the passage, and into grooves of the first and second arms.

11. The gripper of claim 1, wherein the lower portion extends to opposite fifth and sixth side surfaces and opposite seventh and eighth side surfaces,
wherein opposite edges of the fifth and sixth side surfaces each meet an edge of one of the opposite seventh and eighth side surfaces,
wherein the upper portion extends along a center plane that extends between the fifth and sixth side surfaces and in parallel to and centered by the seventh and eighth side surfaces, and
wherein the third and fourth side surfaces of the upper portion are disposed equidistant from the center plane.

12. A gripper for gripping a soft tube for punching, comprising:
a first arm and a second arm, wherein the first arm and the second arm are moveable relative to each other,
wherein the gripper has an open configuration and a closed configuration, and
wherein the first arm and the second arm are configured such that when the gripper is in the closed configuration, a tunnel is formed collectively by the first and second arms and configured to receive at least a portion of a soft tube such that at least the portion of the soft tube received in the tunnel is prevented from collapsing when force is applied to a wall of the portion of the soft tube received in the tunnel.

13. The gripper of claim 12, wherein the tunnel has an inner diameter that is between about 1% and about 5% smaller than a default outer diameter of the portion of the tube received in the tunnel.

14. The gripper of claim 12, wherein the first and second arms are further configured such that when the gripper is in the closed configuration, a passage is formed collectively by the first and second arms and configured to allow at least a portion of an elongate member to extend from above top surfaces of the first and second arms, through the passage, and into the tunnel.

15. A gripper for gripping a tube for punching, comprising:
a first arm including a lower portion and an upper portion disposed outwardly from an upper surface of the lower portion,
wherein the upper portion extends to opposite first and second side surfaces and opposite third and fourth side surfaces,
wherein opposite edges of the first and second side surfaces each meet an edge of one of the opposite third and fourth side surfaces, and
wherein the second side surface includes a groove extending from the second side surface towards the first side surface and along a length of the second side surface.

16. The gripper of claim 15, wherein the groove is configured to receive at least a portion of a tube when a second arm like the first arm is disposed adjacent to and aligned with the first arm.

17. The gripper of claim 16, wherein the groove is configured such that, when the second arm is disposed aligned with the first arm and positioned such that second side surfaces of the first and second arms are in contact with each other, a tunnel is formed collectively by grooves of the first and second arms, and wherein the tunnel is configured to receive at least a portion of a tube such that at least the portion of the tube received in the tunnel is prevented from collapsing when force is applied to a wall of the portion of the tube received in the tunnel.

18. The gripper of claim 17, wherein the tunnel has an inner diameter that is between about 1% and about 5% smaller than a default outer diameter of the portion of the tube received in the tunnel.

19. The gripper of claim 15, wherein the upper portion includes a slot that extends from the second side surface towards the first side surface, and wherein the slot extends from a top surface of the upper portion towards the upper surface of the lower portion and to a plane that at least meets the groove at an upper edge of the groove.

20. The gripper of claim 19, wherein when a second arm like the first arm is disposed aligned with the first arm and positioned such that second side surfaces of the first and second arms are in contact with each other, slots of the first and second arms collectively form a passage configured to allow at least a portion of an elongate member to extend from above top surfaces of the first and second arms, through the passage, and into grooves of the first and second arms.
